(19) United States
(12) Patent Application Publication
(10) Pub. No.: US 2005/0115236 A1
(43) Pub. Date: Jun. 2, 2005

(54) Master cylinder with a braking stroke simulator

(76) Inventor: Akihito Kusano, Toyota city (JP)

Correspondence Address: BURNS DOANE SWECKER & MATHIS L L P, POST OFFICE BOX 1404, ALEXANDRIA, VA, 22313-1404, US

(21) Appl. No.: 10/976,930

(22) Filed: Nov. 1, 2004

(30) Foreign Application Priority Data
Nov. 17, 2003 (JP) 2003-386661
Nov. 17, 2003 (JP) 2003-386662
Apr. 27, 2004 (JP) 2004-131804

(51) Int. Cl. F15B 7/00

(52) U.S. Cl. 60/533

(57) ABSTRACT

A piston member is slidably accommodated in a cylinder bore for defining a master pressure chamber. A simulator piston is provided for defining a simulator chamber and moving in response to operation of a brake pedal. An annular groove is formed on the inner surface of the cylinder bore with a certain width along a longitudinal axis of the cylinder bore, and a seal member is mounted around the piston member. The simulator chamber is communicated with the atmospheric pressure chamber through a clearance between the seal member and the annular groove, when the piston member is placed in the initial position thereof, whereas the communication between the simulator chamber and the atmospheric pressure chamber is blocked, with the seal member being placed to contact the inner surface of the cylinder bore, when the auxiliary piston is advanced from the initial position thereof by the predetermined distance or more.

This application claims priorities under 35 U.S.C. Sec.119 to Nos. 2003-386661 filed in Japan on Nov. 17, 2003, 2003-386662 filed in Japan on Nov. 17, 2003, and 2004-131804 filed in Japan on Apr. 27, 2004, the entire contents of which are herein incorporated by reference.

### BACKGROUND OF THE INVENTION

1. Field of the Invention

The present invention relates to a master cylinder for use in a hydraulic brake apparatus of a vehicle, and more particularly to a master cylinder with a braking stroke simulator operated in response to operation of a manually operated braking member.

2. Description of the Related Arts

Heretofore, there is known various hydraulic brake apparatuses each having a master cylinder with a braking stroke simulator. Among them, such an apparatus as discussed below has been disclosed in Japanese Patent Laid-open publication No.11-59349. According to the apparatus, when a pressure control device including a pressure source is normal, the hydraulic pressure generated by the pressure source is controlled by the pressure control device in response to operation of a manually operated braking member to be supplied into wheel brake cylinders, with the communication between the master cylinder and the wheel brake cylinder being blocked. When the pressure control device has come to be abnormal, the master cylinder is communicated with the wheel brake cylinder, to discharge the hydraulic pressure into the wheel brake cylinder in response to operational force of the manually operated braking member.

In general, the stroke simulator is adapted to provide the manually operated braking member with a stroke in response to the braking operation force, when the pressure control device is normal, i.e., when the communication between the master cylinder and the wheel brake cylinder has been blocked. And, according to the hydraulic brake apparatus as disclosed in the Japanese Patent Laid-open publication, the stroke simulator is disposed between the manually operated braking member and a master piston. In view of the fact that it is required to provide a large stroke of a brake pedal in response to a stroke of the stroke simulator, when the pressure control device is abnormal, i.e., when the hydraulic pressure is supplied from the master cylinder to the wheel brake cylinder, there is provided cut-off means for blocking the communication between a simulator chamber and an atmospheric pressure chamber in response to movement of the master piston. As for the cut-off means, there are provided a sleeve in contact with a part of inner surface of a cylinder body, and a seal member fixed to the master piston, whereby the stroke of the stroke simulator may be restricted, when the hydraulic pressure is supplied from the master cylinder to the wheel brake cylinder.

According to the hydraulic brake apparatus as disclosed in the Japanese Patent Laid-open publication, however, if the pressure control device became abnormal, the seal member would close a port formed on the sleeve, to block the communication between the simulator chamber and the atmospheric pressure chamber. Therefore, the sleeve is required to serve as the cut-off means, so that the apparatus costs much. Otherwise, if the sleeve was omitted from the apparatus as disclosed in the Japanese Patent Laid-open publication, and instead the port was formed directly on the cylinder body, communication passages would be complicated, so that the apparatus would cost much, as well.

Also, if the pressure control device becomes abnormal for example, it is desirable to block the communication between the communication between the simulator chamber and the atmospheric pressure chamber, when the master piston is advanced slightly over a so-called port idle for blocking the communication between the communication between the master pressure chamber and the atmospheric pressure chamber, in order to reduce a stroke of the stroke simulator as small as possible. Therefore, a high dimensional accuracy is required for positioning ports formed on the master piston, grooves for holding the seal members, and ports formed on the sleeve, so that the apparatus would cost much. According to the hydraulic brake apparatus as disclosed in the Japanese Patent Laid-open publication, the port idle will cause a so-called dead stroke, which will result in increasing the stroke of the manually braking member when the pressure control device becomes abnormal. In order to reduce the size of the port idle, therefore, a high dimensional accuracy is required for setting dimensions of the cylinder housing, a cup-like spring holder, and axial members or the like, so that the apparatus would cost much, as well.

### SUMMARY OF THE INVENTION

Accordingly, it is an object of the present invention to provide a master cylinder having a braking stroke simulator used for a component of a hydraulic brake apparatus for a vehicle, which is capable of restricting a stroke of a manually operated braking member when the hydraulic pressure is supplied from the master cylinder to wheel brake cylinders.

And, it is another object of the present invention to provide an inexpensive apparatus provided with a master cylinder having a braking stroke simulator, which is capable of blocking the communication between a simulator chamber and an atmospheric pressure chamber appropriately, when a master piston is advanced.

In order to accomplish the above and other objects, the master cylinder is provided with a piston member which is slidably accommodated in a cylinder bore of a cylinder housing for defining a master pressure chamber in front of the piston member, and a stroke simulator which has a simulator piston for defining a simulator chamber in front of the simulator piston and moving back and forth in response to operation of a manually operated braking member, and an elastic member for applying a stroke of the simulator piston in response to braking operation force of the manually operated braking member. The stroke simulator is adapted to transmit the braking operation force of the manually operated braking member to the piston member, through the simulator piston and the elastic member. Furthermore, a communication control device is provided for communicating the simulator chamber with the atmospheric pressure chamber when the piston member is placed in an initial position thereof, and blocking the communication between the simulator chamber and the atmospheric pressure chamber in response to movement of the piston member advanced from the initial position thereof. The communication control device includes a seal member mounted on one of the piston member and the inner surface of the cylinder bore. The communication control device is adapted to communicate the simulator chamber with the atmospheric pressure chamber, in response to a first relative relationship of the seal member with the other one of the piston member and the inner surface of the cylinder bore, when the piston member is placed in the initial position thereof, and adapted to block the communication between the simulator chamber and the atmospheric pressure chamber, in response to a second relative relationship of the seal member with the other one of the piston member and the inner surface of the cylinder bore, when the piston member is advanced from the initial position thereof by a predetermined distance or more.

In the master cylinder with the braking stroke simulator as described above, the communication control device may include an annular groove formed on the inner surface of the cylinder bore with a certain width along a longitudinal axis of the cylinder bore, and the seal member mounted around the piston member. The communication control device is adapted to communicate the simulator chamber with the atmospheric pressure chamber through a clearance between the seal member and the annular groove, when the piston member is placed in the initial position thereof, and adapted to block the communication between the simulator chamber and the atmospheric pressure chamber, with the seal member being placed to contact the inner surface of the cylinder bore, when the piston member is advanced from the initial position thereof by the predetermined distance or more.

The communication control device may include the seal member mounted on the inner surface of the cylinder bore, and a small diameter portion and a large diameter portion formed around the piston member. The communication control device is adapted to communicate the simulator chamber with the atmospheric pressure chamber through a clearance between the seal member and the small diameter portion, when the piston member is placed in the initial position thereof, and adapted to block the communication between the simulator chamber and the atmospheric pressure chamber, with the seal member being placed to contact the large diameter portion, when the piston member is advanced from the initial position thereof by the predetermined distance or more.

Or, the communication control device may include the seal member mounted on the inner surface of the cylinder bore, and a communication passage formed on the piston member. The communication control device is adapted to communicate the simulator chamber with the atmospheric pressure chamber through the communication passage, when the piston member is placed in the initial position thereof, and adapted to block the communication between the simulator chamber and the atmospheric pressure chamber, with the seal member being placed to close the communication passage, when the piston member is advanced from the initial position thereof by the predetermined distance or more.

Preferably, the communication passage is at least a communication hole formed in the piston member in a radial direction thereof. The communication passage may be at least a communication groove formed on the piston member in a longitudinal direction thereof. Or, the communication passage may be at least a cut-out portion formed around a part of the outer peripheral surface of the piston member.

In order to accomplish another object as described above, particularly, the master cylinder may include a master piston which is slidably accommodated in a cylinder bore of a cylinder housing for defining a master pressure chamber in front of the master piston, and a stroke simulator which has a simulator piston for defining a simulator chamber in front of the simulator piston and moving back and forth in response to operation of the manually operated braking member, to communicate the master pressure chamber with the atmospheric pressure chamber when the master piston is placed in an initial position thereof, and block the communication between the master pressure chamber and the atmospheric pressure chamber when the master piston is advanced from the initial position thereof by a first stroke or more. The stroke simulator has an elastic member for applying a stroke of the simulator piston in response to braking operation force of the manually operated braking member. And, the stroke simulator is adapted to transmit the braking operation force of the manually operated braking member to the master piston, through the simulator piston and the elastic member. Furthermore, a communication control device is provided for communicating the simulator chamber with the atmospheric pressure chamber when the master piston is placed in the initial position thereof, and blocking the communication between the simulator chamber and the atmospheric pressure chamber in response to movement of the master piston. And, the communication control device includes an auxiliary piston which is disposed between the master piston and the elastic member, and adapted to block the communication between the simulator chamber and the atmospheric pressure chamber when the auxiliary piston is advanced from the initial position thereof by a second stroke or more. The second stroke is set to be greater than the first stroke by a predetermined distance.

Preferably, the master cylinder further includes a cut-off stroke setting device which is disposed between the master piston and the auxiliary piston for adjusting a distance between the master piston and the auxiliary piston to set the predetermined distance, and which may include a rod disposed between the master piston and the auxiliary piston for adjusting the distance between them.

The master cylinder may further include a port idle setting device for adjusting an initial position of at least one of the master piston and the auxiliary piston to set the first stroke. The port idle setting device may include a stopper secured to the housing for adjusting the initial position of at least one of the master piston and the auxiliary piston.

### BRIEF DESCRIPTION OF THE DRAWINGS

The above stated object and following description will become readily apparent with reference to the accompanying drawings, wherein like reference numerals denote like elements, and in which:

FIG. 1 is a sectional view of a master cylinder with a braking stroke simulator according to an embodiment of the present invention;

FIG. 2 is a schematic block diagram of a hydraulic brake apparatus having a master cylinder with a braking stroke simulator according to an embodiment of the present invention;

FIG. 3 is a sectional view of a master cylinder with a braking stroke simulator according to another embodiment of the present invention;

FIG. 4 is a sectional view of a master cylinder with a braking stroke simulator according to a further embodiment of the present invention;

FIG. 5 is a sectional view of a master cylinder with a braking stroke simulator according to a yet further embodiment of the present invention;

FIG. 6 is a sectional view of a master piston, with a tip end portion of its large diameter portion sectioned in a direction perpendicular to its longitudinal axis according to the embodiment as shown in FIG. 5;

FIG. 7 is a sectional view of another master piston, with a tip end portion of its large diameter portion sectioned in a direction perpendicular to its longitudinal axis according to the embodiment as shown in FIG. 5;

FIG. 8 is a sectional view of a master cylinder with a braking stroke simulator according to a yet further embodiment of the present invention;

FIG. 9 is a sectional view of a part of a master cylinder with a braking stroke simulator having a rod served as an embodiment of a cut-off stroke setting device for use in a communication control device according to the present invention;

FIG. 10 is a sectional view of a part of a master cylinder with a braking stroke simulator having an adjusting rod served as an embodiment of a cut-off stroke setting device according to the present invention;

FIG. 11 is a sectional view of a part of a master cylinder with a braking stroke simulator having an adjusting rod served as another embodiment of a cut-off stroke setting device according to the present invention;

FIG. 12 is a sectional view of a part of a master cylinder with a braking stroke simulator having an adjusting rod served as a further embodiment of a cut-off stroke setting device according to the present invention;

FIG. 13 is a sectional view of a part of a master cylinder with a braking stroke simulator having a stopper rod served as an embodiment of a port idle setting device according to the present invention;

FIG. 14 is a sectional view of a part of a master cylinder with a braking stroke simulator having a stopper rod served as another embodiment of a port idle setting device according to the present invention;

FIG. 15 is a sectional view of a portion to be screwed with the stopper as shown in FIG. 8 and a portion to be screwed with the adjusting rod as shown in FIG. 10; and

FIG. 16 is a schematic block diagram of a hydraulic brake apparatus having a master cylinder with a braking stroke simulator according to the embodiment as shown in FIG. 8.

### DESCRIPTION OF THE PREFERRED EMBODIMENTS

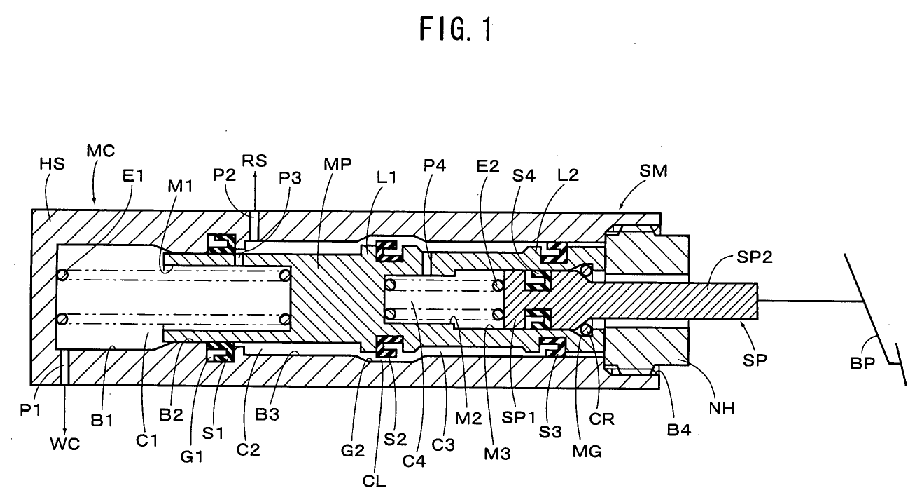

Referring to FIG. 1, there is illustrated a master cylinder MC with a stroke simulator SM formed in a body according to an embodiment of the present invention, which includes a master piston MP served as a piston member of the present invention and slidably accommodated in a cylinder housing HS, with a simulator piston SP slidably accommodated in the master piston MP. The housing HS is closed in its front end (leftward in FIG. 1) to be formed in a cylinder with a bottom, with a cylinder bore having a stepped bore of a recess B1, a small diameter bore B2 and a large diameter bore B3. At the rear end of the housing HS, there is formed an open end portion B4 with threaded grooves formed therein. On the inner surface of the small diameter bore B2, an annular groove G1 is formed for holding a seal member S5 having a cup-like cross section, whereas on the inner surface of the large diameter bore B3, there is formed an annular groove G2 having a certain width along the longitudinal axis of the bore B3. On the side wall of the housing HS, there are formed a port P1 opening into the recess B1, and a port P2 opening into the large diameter bore B3 near the small diameter bore B2. The housing HS may be made of a single metallic member, because those recess B1, small diameter bore B2, large diameter bore B3, open end portion B4, and annular grooves G1 and G2 can be formed by boring the housing HS along the longitudinal axis thereof.

As for the master piston MP, there are formed at its front end a recess M1 opening forward, and formed at its rear end a recess opening rearward, in the latter of which a cylinder bore is formed to provide a stepped bore of a small diameter bore M2 and a large diameter bore M3. On the inner surface of the large diameter bore M3 near the open end thereof, an annular groove MG is formed for holding a C-ring CR as described later. On the side wall of the master piston MP, there are formed a port P3 opening into the recess M1, and a port P4 opening into the small diameter bore M2. A land portion L1 is formed around the outer peripheral surface of a middle portion of the master piston MP, and a land portion L2 is formed around the outer peripheral surface of its rear portion, with annular grooves formed on their outer surfaces, to hold therein annular seal members S2 and S3 having cup-like cross sections, respectively.

The simulator piston SP has a large diameter piston portion SP1 to be slidably accommodated in the large diameter bore M3, and a small diameter axial portion SP2 extending rearward from the former. On the outer peripheral surface of the piston portion SP1, there is formed an annular groove for holding therein an annular seal member S4 having a cup-like cross section. The axial portion SP2 is connected to a brake pedal BP served as the manually operated braking member. The seal members S1 and S2 act as a check valve, respectively, to block the flow of brake fluid from the opened side of cup-like cross section to the closed side thereof, and allow the flow of brake fluid from the closed side to the opened side, so that the seal member S2 allows the flow of brake fluid from the front side (left side in FIG. 1) to the rear side, and blocks its reverse flow.

Next will be explained the parts as described above, according to an example of a sequence of steps for assembling them. At the outset, a compression spring E2 served as an elastic member for the simulator is received into the small diameter bore M2 and large diameter bore M3 of the master piston MP. Then, the simulator piston SP with the seal member S4 mounted thereon is fluid-tightly and slidably received into the large diameter bore M3 to define a simulator chamber C4 in front of the piston portion SP1. With the piston portion SP1 accommodated in the large diameter bore M3, the C-ring CR is fitted into the annular groove MG of the master piston MP, to prevent the simulator piston SP from being moved rearward against biasing force of the compression spring E2. Then, the seal members S2 and S3 are mounted on the land portions L1 and L2 of the master piston MP, respectively.

Next, the seal member S1 is fitted into the annular groove G1 of the housing HS, and a compression spring E1 served as a return spring is received in the recess B1 of the housing HS and the recess M1 of the master piston MP, and then the master piston MP is fitted into the small diameter bore B2 and large diameter bore B3. Consequently, the master piston MP is fluid-tightly and slidably accommodated in the small diameter bore B2 and large diameter bore B3, through the seal members S1 and S3, respectively. Thus, with the master piston MP accommodated in the small diameter bore B2 and large diameter bore B3 of the housing HS, screwed into the open end portion B4 of the housing HS is a nut-like stopper NH with threaded grooves formed on its outer peripheral surface, which prevents the master piston MP from being moved rearward against the biasing force of the compression spring E1.

With those parts assembled as described above, the master pressure chamber C1 is defined in front of the master piston MP in the master cylinder MC, to be communicated with the wheel brake cylinder WC through the port P1 (via an electromagnetic switching valve NO as described hereinafter). An atmospheric pressure chamber C2 is formed between the seal members S1 and S2 held on the inner peripheral surface of the housing HS, and an annular chamber C3 is formed between the seal members S2 and S3, so that the atmospheric pressure chamber C2 is so constituted to be always communicated with an atmospheric pressure reservoir RS (hereinafter, simply referred to as a reservoir RS) through the port P2. When the master piston MP is placed in its initial position as shown in FIG. 1, therefore, the master pressure chamber C1 is communicated with the atmospheric pressure chamber C2 through the port P3, and finally communicated with the reservoir RS under the atmospheric pressure, through the port P2. On the contrary, when the master piston MP is advanced from its initial position by a first stroke and more, the opening area of the port P3 is closed by the seal member S1, thereby to block the communication between the master pressure chamber C1 and the atmospheric pressure chamber C2 (and the reservoir RS). At the same time, when the master piston MP is placed in its initial position as shown in FIG. 1, the atmospheric pressure chamber C2 is communicated with the annular chamber C3 through the clearance CL between the seal member S2 and the annular groove G2, and therefore the simulator chamber C4 is communicated with the annular chamber C3 and the atmospheric pressure chamber C2 through the port P4, whereby the simulator chamber C4 is communicated with the reservoir RS through the port P2. And, when the master piston MP is advanced from the initial position thereof by a second stroke, which is greater than the first stroke, or more, the communication between the annular chamber C3 (then, the simulator chamber C4) and the atmospheric pressure chamber C2 will be blocked by the seal member S2 and the inner surface of the large diameter bore B3. Thus, a communication control device according to the present invention is constituted.

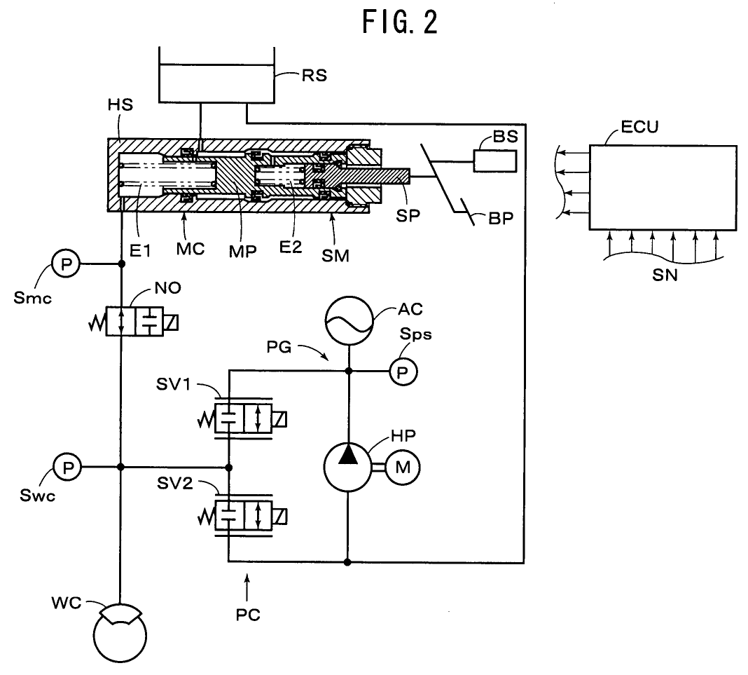

The master cylinder with the braking stroke simulator as described above is provided to constitute a hydraulic brake apparatus for a vehicle as shown in FIG. 2, wherein the master pressure chamber C1 of the master cylinder MC is connected to a wheel brake cylinder WC operatively mounted on each wheel of the vehicle through a normally open electromagnetic switching valve NO. And, a pressure source PG for generating a certain hydraulic pressure irrespective of the braking operation of the vehicle driver is connected to a hydraulic passage between the switching valve NO and the wheel brake cylinder WC.

According to the present embodiment, the pressure source PG includes an electric motor M controlled by an electronic control unit ECU, and a hydraulic pressure pump HP, which is driven by the electric motor M, and whose inlet is connected to the reservoir RS, and whose outlet is connected to an accumulator AC. According to the present embodiment, a pressure sensor Sps is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits. The accumulator AC is connected to a hydraulic passage between the switching valve NO and the wheel brake cylinder WC, through a first linear solenoid valve SV1 of a normally closed type, to regulate the hydraulic pressure discharged from the pressure source PG and supply it to the wheel brake cylinder WC. Also, the reservoir RS is connected to the hydraulic passage between the switching valve NO and wheel brake cylinder WC, through a second linear solenoid valve SV2 of a normally closed type, to reduce the pressure in the wheel brake cylinder WC and regulate it. Accordingly, a pressure control device PC is formed by the pressure source PG, first and second linear solenoid valves SV1 and SV2, electronic control unit ECU, and sensors as described hereinafter.

According to the present embodiment, a pressure sensor Smc is disposed in a hydraulic passage between the master cylinder MC and the switching valve NO, and a pressure sensor Swc is disposed in a hydraulic passage between the switching valve NO and the wheel brake cylinder WC. On the brake pedal BP, a stroke sensor BS is operatively connected to detect its stroke. The signals detected by the sensors as described above are fed to the electronic control unit ECU. Thus, the hydraulic braking pressure discharged from the master cylinder MC, the hydraulic braking pressure in the wheel brake cylinder WC and the stroke of the brake pedal BP are monitored by those sensors. Furthermore, in order to achieve those controls including an anti-skid control or the like, sensors SN such as wheel speed sensors, acceleration sensor or the like have been provided, so that the signals detected by them are fed to the electronic control unit ECU.

Hereinafter, explained is operation of the hydraulic brake apparatus having the master cylinder MC with the braking stroke simulator SM as constituted above. At the outset, when the pressure control device PC is normal, the switching valve NO is energized to be placed in its closed position, so that the communication between the master cylinder MC and the wheel brake cylinder WC is blocked, and the hydraulic pressure discharged from the master cylinder MC is supplied to the wheel brake cylinder WC in response to operation of the brake pedal BP, on the basis of the value detected by the stroke sensor BS and the pressure sensor Smc. That is, the electric current fed to the first and second linear solenoid valves SV1 and SV2 is controlled respectively, so that the wheel cylinder pressure detected by the pressure sensor Swc equals to a desired wheel cylinder pressure. Consequently, the hydraulic pressure controlled by the pressure control device PC in response to operation of the brake pedal BP is supplied to the wheel brake cylinder WC.

In the case where the pressure control device PC is normal as described above, according to the master cylinder MC, the master piston MP is not advanced substantially from such a position that the communication between the master pressure chamber C1 and the atmospheric pressure chamber C2 is blocked. Therefore, the simulator chamber C4 is communicated with the atmospheric pressure chamber C2 and finally with the reservoir RS, through the clearance CL between the seal member S2 and the annular groove G2 formed in the housing HS, so that the simulator chamber C4 is under the atmospheric pressure. Accordingly, if the braking operation force applied to the simulator piston SP becomes equal to or greater than a compressive force for mounting the compression spring E2 in the stroke simulator SM, the compression spring E2 is compressed to provide the stroke of the simulator piston SP in response to the braking operation force. As a result, the stroke of the brake pedal BP is provided in response to the braking operation force.

On the contrary, in the case where the pressure control device PC including the pressure source PG and the like comes to be abnormal, the switching valve NO is de-energized (turned off) to be placed in its open position, so that the master cylinder MC and the wheel brake cylinder WC are communicated with each other, as shown in FIG. 2. At the same time, the first and second linear solenoid valves SV1 and SV2 are de-energized (turned off) to be placed in their closed positions, respectively, so that the hydraulic pressure is not supplied from the pressure source PG to the wheel brake cylinder WC. In this state, therefore, when the brake pedal BP is depressed, to advance the master piston MP by the second stroke or more from the initial position in response to operation of the brake pedal BP, the seal member S2 will contact the large diameter bore B3 formed in the housing HS, to block the communication between the simulator chamber C4 and the atmospheric pressure chamber C2. Hereafter, therefore, the master piston MP will be advanced, without the compression spring E2 being compressed in response to operation of the brake pedal BP, to discharge the hydraulic pressure from the master pressure chamber C1 to the wheel brake cylinder WC.

In this case, even in such a state that the communication between the simulator chamber C4 and the atmospheric pressure chamber C2 is blocked, with the master piston MP being advanced, if the pressure control device PC comes to be abnormal during the operation of the brake pedal BP, i.e., when the stroke simulator SM is being stroked, the stroke simulator SM will be immediately retracted to its initial position by releasing the brake pedal BP to communicate the simulator chamber C4 with the atmospheric pressure chamber C2 through the seal member S2 with its function as a check valve. In other words, the position of the simulator piston SP relative to the position of the master piston MP is placed to be in its initial position. Therefore, a so-called dead stroke could be prevented effectively, even if the brake pedal BP was operated more. Also, even if the brake pedal BP was rapidly released from such a state that the communication between the simulator chamber C4 and the atmospheric pressure chamber C2 was blocked, the simulator piston SP could only be moved rearward up to the position where it would contact the C-ring CR. In other words, as the retracting operation of the simulator piston SP is restricted by the C-ring CR at the rearmost position of the simulator piston SP to be determined relative to the master piston MP when the brake pedal BP has not been depressed, the master piston MP will not be prevented from being moved rearward. Therefore, the master piston MP could be moved rearward until its rear end will contact the stopper NH, so that the master pressure chamber Cl could be definitely opened to communicate with the reservoir RS.

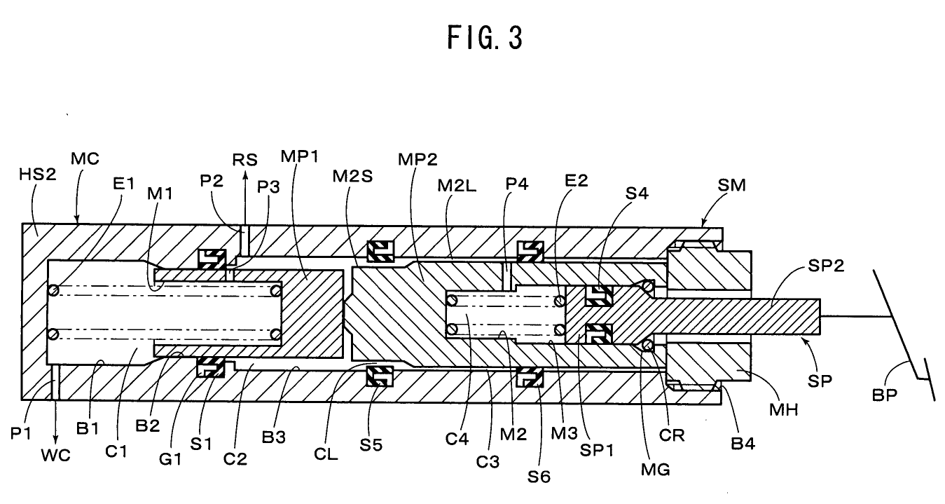

Next, another embodiment of the present invention is explained referring to FIG. 3, wherein structural elements equivalent to those as shown in FIG. 1 are designated by corresponding reference numerals. According to the present embodiment, the master piston MP as shown in FIG. 1 is divided into two sections of a master piston MP1 and an auxiliary piston MP2, the latter of which is formed into a stepped piston having a small diameter portion M2S and a large diameter portion M2L. A housing HS2 is not formed with an annular groove corresponding to the annular groove G2 as shown in FIG. 1, but formed with annular grooves for holding annular seal members S5 and S6 having cup-like cross sections, which act as the seal members S2 and S3 as shown in FIG. 1. According to the embodiment as shown in FIG. 3, therefore, the communication control device of the present invention is constituted by the seal member S5 and a step formed between the small diameter portion M2S and the large diameter portion M2L. In other words, the communication control device includes the seal member S5 disposed on the inner surface of the large diameter bore B3, and includes the small diameter portion M2S and the large diameter portion M2L. When the master piston MP1 and auxiliary piston MP2 are placed in their initial positions, respectively, as shown in FIG. 3, the simulator chamber C4 is communicated with the atmospheric pressure chamber C2 through the clearance CL defined between the seal member S5 and the small diameter portion M2S. And, if the master piston MP1 and auxiliary piston MP2 are advanced from the initial positions by the second stroke or more, the large diameter portion M2L will contact the seal member S5, so that the communication between the simulator chamber C4 and the atmospheric pressure chamber C2 will be blocked.

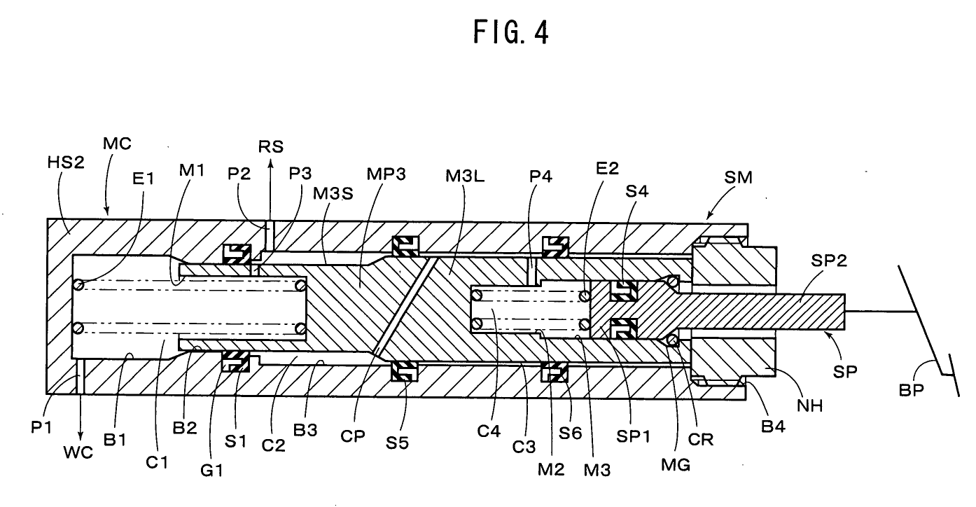

FIG. 4 illustrates a further embodiment of the present invention, wherein structural elements equivalent to those as shown in FIG. 1 are designated by corresponding reference numerals. According to the present embodiment, a master piston MP3 is formed into a stepped piston having a small diameter portion M3S and a large diameter portion M3L. Like the embodiment as shown in FIG. 3, the housing HS2 is not formed with an annular groove corresponding to the annular groove G2 as shown in FIG. 1, but formed with the annular grooves for holding the annular seal members S5 and S6 having cup-like cross sections, which act as the seal members S2 and S3 as shown in FIG. 1. According to the present embodiment, however, the seal member S5 is placed to be in contact with the large diameter portion M3L as shown in FIG. 4, when the master piston MP3 is placed in its initial position, which is different from the embodiment as shown in FIG. 3. And, a communication hole CP is formed to penetrate the master piston MP3 in a radial direction thereof, to communicate the annular chamber C3 formed between the seal members S5 and S6 with the atmospheric pressure chamber C2 formed between the seal member S1 and the seal member S5.

Therefore, when the master piston MP3 is placed in its initial position as shown in FIG. 4, the simulator chamber C4 is communicated with the atmospheric pressure chamber C2 through the communication hole CP. And, if the master piston MP3 is advanced from the initial position by a predetermined distance or more, the communication hole CP will be closed by the seal member S5 not to communicate with the annular chamber C3 and the simulator chamber C4, so that the communication between the simulator chamber C4 and the atmospheric pressure chamber C2 will be blocked. Thus, the communication control device of the present invention is constituted by the communication hole CP and the seal member S5, according to the embodiment as shown in FIG. 4.

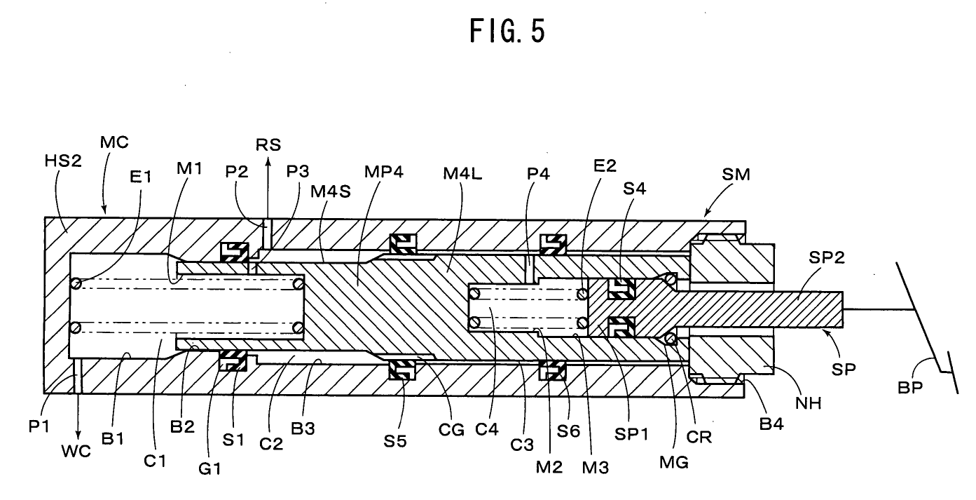

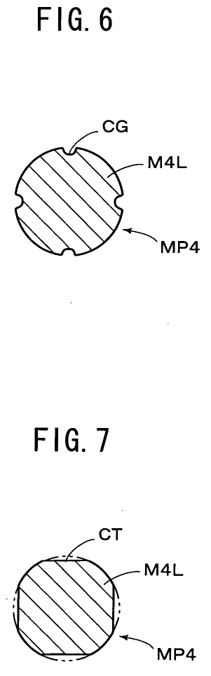

FIG. 5 illustrates a yet further embodiment of the present invention, wherein structural elements equivalent to those as shown in FIG. 4 are designated by corresponding reference numerals. According to the present embodiment, a master piston MP4 is formed into a stepped piston having a small diameter portion M4S and a large diameter portion M4L, like the master piston MP3 as shown in FIG. 4. The housing HS2 is not formed with the annular groove corresponding to the annular groove G2 as shown in FIG. 1, but formed with the annular grooves for holding the annular seal members S5 and S6 having cup-like cross sections, which act as the seal members S2 and S3 as shown in FIG. 1. According to the present embodiment, communication grooves CG are formed longitudinally on the tip end portion of the large diameter portion M4L, as shown in FIGS. 5 and 6. When the master piston MP4 is placed in its initial position as shown in FIG. 5, the seal member S5 is positioned to contact the outer peripheral surface of the large diameter portion M4L, so that the simulator chamber C4 communicates with the annular chamber C3 and the atmospheric pressure chamber C2, through the communication grooves CG. And, if the master piston MP4 is advanced from its initial position by a predetermined distance or more, the communication grooves CG will be closed by the seal member S5 not to communicate with the annular chamber C3 and the simulator chamber C4, so that the communication between the simulator chamber C4 and the atmospheric pressure chamber C2 will be blocked. Thus, the communication control device of the present invention is constituted by the communication grooves CG and the seal member S5, according to the embodiment as shown in FIG. 5.

Instead of the communication grooves CG as shown in FIG. 6, cut-out sections CT may be formed as shown in FIG. 7, around a part of the outer peripheral surface (as indicated by two-dotted chain line in FIG. 7) of an end portion of the large diameter portion M4L to be cut out longitudinally. According to the present embodiment, therefore, when the master piston MP4 is placed in its initial position, the simulator chamber C4 is communicated with the annular chamber C3 and the atmospheric pressure chamber C2, through the cut-out sections CT. And, if the master the master piston MP4 is advanced from the initial position thereof by a predetermined distance or more, the cut-out sections CT will be closed by the seal member S5 not to communicate with the annular chamber C3 and the simulator chamber C4, so that the communication between the simulator chamber C4 and the atmospheric pressure chamber C2 will be blocked. Thus, the communication control device of the present invention is constituted by the cut-out sections CT and the seal member S5, according to the embodiment as shown in FIG. 7. According to the embodiments as described above, the master cylinder MC may be formed to provide a tandem master cylinder having a couple of master pressure chambers.

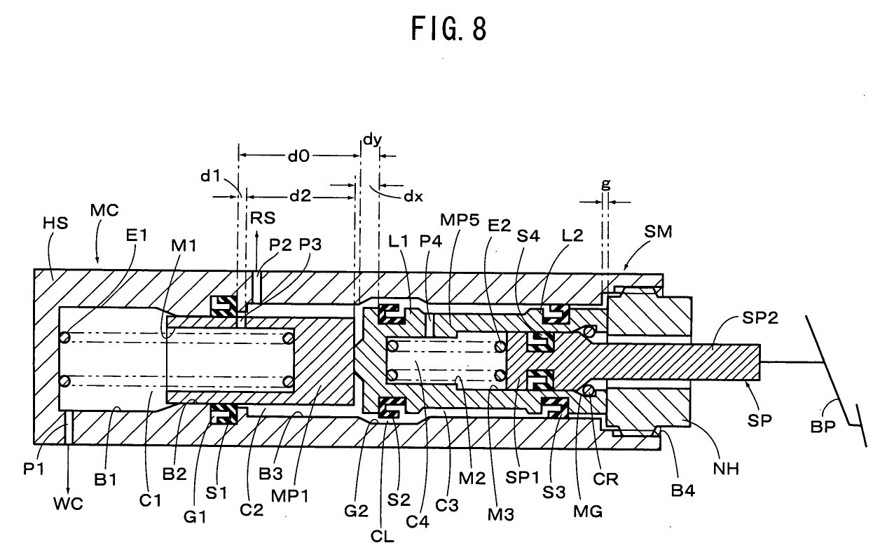

Next, referring to FIG. 8, explained is a yet further embodiment of the present invention, wherein structural elements equivalent to those describe in FIG. 1 are designated by corresponding reference numerals. Instead of the master piston MP as shown in FIG. 1, a master piston MP1 and an auxiliary piston MP5 are accommodated in the housing HS according to the present embodiment. In a rear end portion of the auxiliary piston MP5, there are defined a small diameter bore M2 and a large diameter bore M3 for receiving therein the compression spring E2 and simulator piston SP. According to the same manner as in the aforementioned embodiment, the C-ring CR is fitted into the annular groove MG of the auxiliary piston MP2 in the state that the piston portion SP1 of the simulator piston SP is received in the large diameter bore M3, to prevent the simulator piston SP from being moved rearward against the biasing force of the compression spring E2, so that the rearmost position of the simulator piston SP relative to the auxiliary piston MP5 is defined. With the master piston MP1 and auxiliary piston MP5 accommodated in the small diameter bore B2 and large diameter bore B3 of the housing HS, the nut-like stopper NH is screwed into the open end portion B4. By means of the stopper NH, therefore, the master piston MP1 and auxiliary piston MP5 are prevented from being moved rearward against the biasing force of the compression spring El, to set the initial position as described later. For this purpose, after the initial position was adjusted, there has been remained a clearance (g) between the front end of the open end portion B4 of the housing HS and the stopper NH, as shown in FIG. 8.

Then, in the same fashion as the embodiment as shown in FIG. 1, the communication control device according to the present embodiment is constituted such that if the master piston MP1 and auxiliary piston MP5 are advanced from their initial positions by the second stroke or more, the communication between the annular chamber C3 (then, the simulator chamber C4) and the atmospheric pressure chamber C2 will be blocked by the seal member S2 and the inner surface of the large diameter bore B3. The communication control device may be constituted as follows. At the outset, there are provided in advance several kinds of piston members having different dimensions (dx) from the tip end surface to the groove for receiving therein the front seal member S2. It is preferable to form an protrusion on the tip end of the auxiliary piston MP5, and adjust its height to set the dimension (dx). Then, an appropriate piston member to be used for the auxiliary piston MP5 is selected from the several kinds of piston members prepared in advance, according to a dimension (d0) from a rear end of the groove of the housing HS for receiving therein the seal member S1 up to the annular groove G2, and a dimension (d2) from the port P3 of the master piston MP1 to the rear end surface, which will contact the auxiliary piston MP5. In other words, the piston member is selected to provide the second stroke (dy), which is the distance of the auxiliary piston MP5 advanced from the initial position thereof until it blocks the communication between the simulator chamber C4 and the atmospheric pressure chamber C2, to be greater than the first stroke (d1), which is the distance of the master piston MP1 advanced from the initial position thereof until it blocks the communication between the master pressure chamber C1 and the atmospheric pressure chamber C2, by a predetermined distance (k), to be (dy−d1=k), i.e., the piston member to meet (d2+dx−d0=k) is selected.

Or, there may be provided in advance a standard piston member (not shown) as an auxiliary piston without the simulator piston SP being assembled. Then, with air being supplied from the port P2 of the housing HS connected to the reservoir RS, the moving distance (dy−d1) of the standard piston and the master piston MP1 is measured, when they are advanced from their initial positions until the communication between the master pressure chamber C1 and the atmospheric pressure chamber C2 is blocked, then the communication between the simulator chamber C4 and the atmospheric pressure chamber C2 is blocked. Then, the piston member may be selected to be served as the auxiliary piston MP5, on the basis of the measured result (dy−d1). Or, with air being supplied from the port P2 of the housing HS, the stopper NH is advanced to a position where the communication between the master pressure chamber C1 and the atmospheric pressure chamber C2 is blocked, then the stopper NH is slightly moved rearward from that position, whereby a port idle can be set to provide the first stroke (d1).

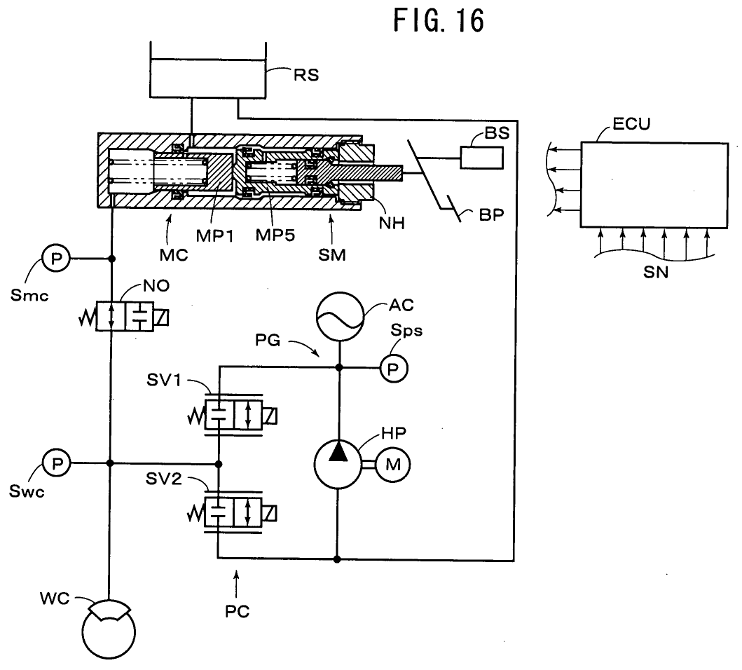

The master cylinder with the braking stroke simulator as shown in FIG. 8 is provided to constitute the hydraulic brake apparatus as shown in FIG. 16, which is substantially the same as the apparatus as shown in FIG. 2, except for the structure of the master cylinder with the braking stroke simulator as shown in FIG. 1. And, the master cylinder as shown in FIG. 8 operates substantially in the same manner as the master cylinder as shown in FIG. 1, so that explanation of its basic operation is omitted herein. According to the present embodiment, even if the brake pedal BP was rapidly released from the state that the communication between the simulator chamber C4 and the atmospheric pressure chamber C2 was blocked, the simulator piston SP could only move up to the position where it would contact the C-ring CR. In other words, as the retracting operation of the simulator piston SP is restricted by the C-ring CR at its rearmost position of the simulator piston CP to be determined relative to the auxiliary piston MP5 when the brake pedal BP has not been depressed, the auxiliary piston MP5 will not be prevented from being moved rearward. Therefore, the master piston MP1 and auxiliary piston MP5 could be moved rearward until the rear end of the auxiliary piston MP5 will contact the stopper NH, so that the master pressure chamber C1 could be definitely opened to communicate with the reservoir RS.

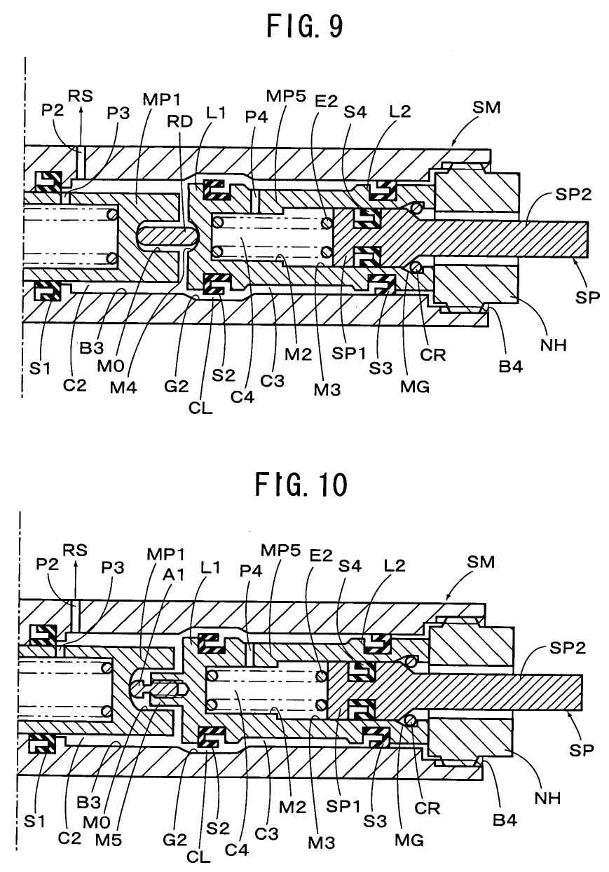

FIGS.9-12 show embodiments of the cut-off stroke setting device according to the present invention for adjusting the distance between the master piston MP1 and the auxiliary piston MP5 to set the predetermined distance (dy−d1=k), an example of which is a rod disposed between the master piston MP1 and the auxiliary piston MP5. According to the embodiment as shown in FIG. 9, it is so constituted that an appropriate rod RD is selected from several kinds of rods of different dimensions. The rod RD is disposed between the recess M0 formed on the rear end surface of the master piston MP1 and the recess M4 formed on the front end surface of the auxiliary piston MP5, as shown in FIG. 9.

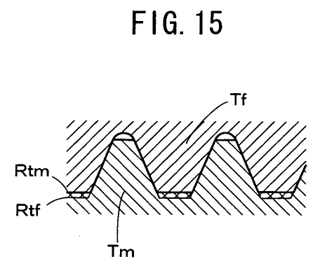

FIG. 10 shows another embodiment of the cut-off stroke setting device according to the present invention for adjusting the distance between the master piston MP1 and the auxiliary piston MP5 to be fixed at the predetermined distance. As shown in FIG. 10, an adjusting rod A1 is screwed into a cylindrical protrusion M5, which is formed to extend into the recess M0 of the master piston MP1 from the front end of the auxiliary piston MP5, so that the tip end of the adjusting rod A1 contacts the inner surface of the recess M0 of the master piston MP1. According to the embodiment as shown in FIG. 10, therefore, the distance between the master piston MP1 and the auxiliary piston MP5 can be adjusted into an appropriate value, by adjusting the depth of the adjusting rod A1 screwed into the protrusion M5. In order to ensure the fixed state of the stopper NH to the open end portion B4 of the housing HS, and ensure the fixed state of the adjusting rod A1 to the auxiliary piston MP5, as shown in FIG. 15 for example, it is preferable to set the diameter Rtm of the bottom of thread of a male screw Tm (at the sides of the stopper NH and adjusting rod A1) to be slightly larger than the inner diameter Rtf of a female screw Tf (at the sides of the housing HS and auxiliary piston MP5), and to screw it firmly so that the parts with the male screw Tm being screwed would not be rotated, whereby positioning of the parts can be made surely.

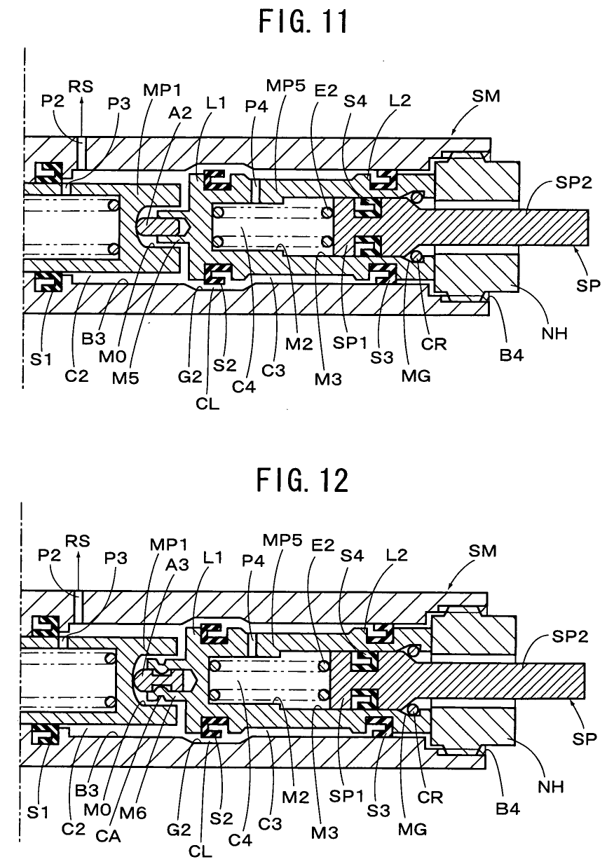

FIGS.11 and 12 show a further embodiment of the cut-off stroke setting device for adjusting the distance between the master piston MP1 and the auxiliary piston MP5 to be fixed at the predetermined distance. In contrast to the device as shown in FIG. 10, wherein the adjusting rod A1 is screwed into the cylindrical protrusion M5, an adjusting rod A2 as shown in FIG. 11 is pressed into the cylindrical protrusion M5 to be fixedly held therein. And, an adjusting rod A3 as shown in FIG. 12 is received in a cylindrical protrusion M6, which is deformed, or caulked to hold the adjusting rod A3 fixedly.

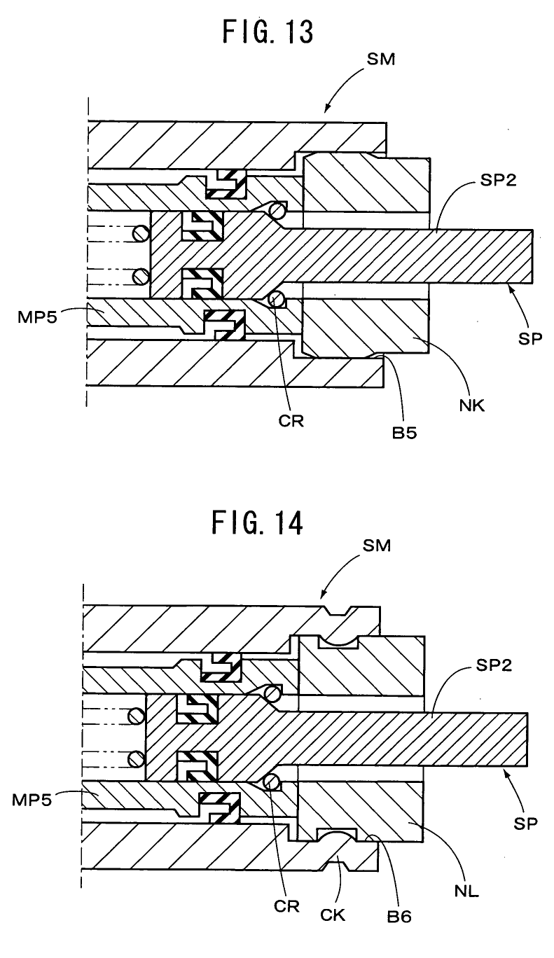

As for the port idle setting device, a stopper may be provided for adjusting the initial position of at least one of the master piston MP1 and the auxiliary piston MP5, to be secured to the housing HS. According to the embodiments as shown in FIGS.8-12, it is so constituted that the stopper NH is screwed into the open end portion B4 of the housing HS with threaded grooves formed on the inner side of the open end portion B4. Then, with air being supplied from the port P2 of the housing HS, the stopper NH is advanced from the initial position thereof until the communication between the master pressure chamber C1 and the atmospheric pressure chamber C2 is blocked, and then the stopper NH is slightly moved rearward, and fixed to set the port idle to provide the distance (d1). In order to fix the stopper, a stopper NL as shown in FIG. 13 may be deformed in an open end portion B6 of the housing HS, to form a caulked portion CK as shown in FIG. 13. Or, a stopper NK as shown in FIG. 14 may be pressed into an open end portion B5 of the housing HS. In the latter case, a standard stopper member (not shown) with a slightly small outer diameter not to be pressed into the open end portion B5, is prepared in advance, and a longitudinal position of the stopper is set as described above. Then, the stopper NK is pressed into the open end portion B5 up to the longitudinal position, so that the port idle may be set to provide the distance (d1).

It should be apparent to one skilled in the art that the above-described embodiments are merely illustrative of but one of the many possible specific embodiments of the present invention. Numerous and various other arrangements can be readily devised by those skilled in the art without departing from the spirit and scope of the invention as defined in the following claims.

1. A master cylinder with a braking stroke simulator operated in response to operation of a manually operated braking member, comprising:
a piston member slidably accommodated in a cylinder bore of a cylinder housing for defining a master pressure chamber in front of said piston member;
a stroke simulator having a simulator piston for defining a simulator chamber in front of said simulator piston and moving back and forth in response to operation of said manually operated braking member, and an elastic member for applying a stroke of said simulator piston in response to braking operation force of said manually operated braking member, said stroke simulator transmitting the braking operation force of said manually operated braking member to said piston member, through said simulator piston and said elastic member; and
communication control means for communicating said simulator chamber with said atmospheric pressure chamber when said piston member is placed in an initial position thereof, and blocking the communication between said simulator chamber and said atmospheric pressure chamber in response to movement of said piston member advanced from the initial position thereof,
wherein said communication control means includes a seal member mounted on one of said piston member and the inner surface of said cylinder bore,
and wherein said communication control means communicates said simulator chamber with said atmospheric pressure chamber, in response to a first relative relationship of said seal member with the other one of said piston member and the inner surface of said cylinder bore, when said piston member is placed in the initial position thereof, and said communication control means blocks the communication between said simulator chamber and said atmospheric pressure chamber, in response to a second relative relationship of said seal member with the other one of said piston member and the inner surface of said cylinder bore, when said piston member is advanced from the initial position thereof by a predetermined distance or more.

2. A master cylinder with a braking stroke simulator as set forth in claim 1, wherein said communication control means includes an annular groove formed on the inner surface of said cylinder bore with a certain width along a longitudinal axis of said cylinder bore, and said seal member mounted around said piston member,
and wherein said communication control means communicates said simulator chamber with said atmospheric pressure chamber through a clearance between said seal member and said annular groove, when said piston member is placed in the initial position thereof, and said communication control means blocks the communication between said simulator chamber and said atmospheric pressure chamber, with said seal member being placed to contact the inner surface of said cylinder bore, when said piston member is advanced from the initial position thereof by the predetermined distance or more.

3. A master cylinder with a braking stroke simulator as set forth in claim 1, wherein said communication control means includes said seal member mounted on the inner surface of said cylinder bore, and a small diameter portion and a large diameter portion formed around said piston member,
and wherein said communication control means communicates said simulator chamber with said atmospheric pressure chamber through a clearance between said seal member and said small diameter portion, when said piston member is placed in the initial position thereof, and said communication control means blocks the communication between said simulator chamber and said atmospheric pressure chamber, with said seal member being placed to contact said large diameter portion, when said piston member is advanced from the initial position thereof by the predetermined distance or more.

4. A master cylinder with a braking stroke simulator as set forth in claim 1, wherein said communication control means includes said seal member mounted on the inner surface of said cylinder bore, and a communication passage formed on said piston member,
and wherein said communication control means communicates said simulator chamber with said atmospheric pressure chamber through said communication passage, when said piston member is placed in the initial position thereof, and said communication control means blocks the communication between said simulator chamber and said atmospheric pressure chamber, with said seal member being placed to close said communication passage, when said piston member is advanced from the initial position thereof by the predetermined distance or more.

5. A master cylinder with a braking stroke simulator as set forth in claim 4, wherein said communication passage is at least a communication hole formed in said piston member in a radial direction thereof.

6. A master cylinder with a braking stroke simulator as set forth in claim 4, wherein said communication passage is at least a communication groove formed on said piston member in a longitudinal direction thereof.

7. A master cylinder with a braking stroke simulator as set forth in claim 4, wherein said communication passage is at least a cut-out portion formed around a part of the outer peripheral surface of said piston member.

8. A master cylinder with a braking stroke simulator as set forth in claim 1, wherein said seal member is an annular seal member having a cup-like cross section to block the flow of brake fluid from the opened side of the cup-like cross section to the closed side thereof, and allow the flow of brake fluid from the closed side to the opened side.

9. A master cylinder with a braking stroke simulator as set forth in claim 1, wherein said piston member includes a master piston slidably received in said cylinder bore for defining said master pressure chamber in front of said master piston, said master piston being opened rearward to accommodate therein said elastic member and said simulator piston.

10. A master cylinder with a braking stroke simulator as set forth in claim 1, wherein said piston member includes a master piston slidably received in said cylinder bore for defining said master pressure chamber in front of said master piston, and an auxiliary piston placed to be in contact with a rear end face of said master piston and formed with a recess being opened rearward of said auxiliary piston, to accommodate therein said elastic member and said simulator piston.

11. A master cylinder with a braking stroke simulator operated in response to operation of a manually operated braking member, comprising:
a master piston slidably accommodated in a cylinder bore of a cylinder housing for defining a master pressure chamber in front of said master piston;
a stroke simulator having a simulator piston for defining a simulator chamber in front of said simulator piston and moving back and forth in response to operation of said manually operated braking member, to communicate said master pressure chamber with said atmospheric pressure chamber when said master piston is placed in an initial position thereof, and block the communication between said master pressure chamber and said atmospheric pressure chamber when said master piston is advanced from the initial position thereof by a first stroke or more, and said stroke simulator having an elastic member for applying a stroke of said simulator piston in response to braking operation force of said manually operated braking member, said stroke simulator transmitting the braking operation force of said manually operated braking member to said master piston, through said simulator piston and said elastic member; and
communication control means for communicating said simulator chamber with said atmospheric pressure chamber when said master piston is placed in the initial position thereof, and blocking the communication between said simulator chamber and said atmospheric pressure chamber in response to movement of said master piston,
wherein said communication control means includes an auxiliary piston disposed between said master piston and said elastic member,
and wherein said communication control,means blocks the communication between said simulator chamber and said atmospheric pressure chamber when said auxiliary piston is advanced from the initial position thereof by a second stroke or more, the second stroke being set to be greater than the first stroke by a predetermined distance.

12. A master cylinder with a braking stroke simulator as set forth in claim 11, further comprising cut-off stroke setting means disposed between said master piston and said auxiliary piston for adjusting a distance between said master piston and said auxiliary piston to set the predetermined distance.

13. A master cylinder with a braking stroke simulator as set forth in claim 12, wherein said cut-off stroke setting means includes a rod disposed between said master piston and said auxiliary piston for adjusting the distance between said master piston and said auxiliary piston.

14. A master cylinder with a braking stroke simulator as set forth in claim 11, further comprising port idle setting means for adjusting an initial position of at least one of said master piston and said auxiliary piston to set the first stroke.

15. A master cylinder with a braking stroke simulator as set forth in claim 14, wherein port idle setting means includes a stopper secured to said housing for adjusting the initial position of at least one of said master piston and said auxiliary piston.

16. A master cylinder with a braking stroke simulator as set forth in claim 11, wherein said auxiliary piston has a recess opened rearward for receiving therein said elastic member and said simulator piston.
